(19) United States
(12) Patent Application Publication
(10) Pub. No.: US 2025/0136052 A1
(43) Pub. Date: May 1, 2025

(54) METHOD FOR PREPARING A CHANGE OF A WIPER BLADE OF A VEHICLE, COMPUTER PROGRAM, AND CORRESPONDING VEHICLE

(71) Applicant: Robert Bosch GmbH, Stuttgart (DE)

(72) Inventors: Michael Kruse, Sinzheim (DE); Manuel Hans Reith, Sinzheim (DE); Vladimir Lichev, Stuttgart (DE)

(21) Appl. No.: 18/923,843

(22) Filed: Oct. 23, 2024

(30) Foreign Application Priority Data
Oct. 26, 2023 (DE) 10 2023 210 575.6

(51) Int. Cl. B60S 1/08; B60S 1/52

(52) U.S. Cl. CPC B60S 1/0818; B60S 1/524

(57) ABSTRACT

A method for preparing a change of a wiper blade of a vehicle, comprising the steps of: Authenticating a first entity as an authorized user of the vehicle, detecting a desire of the first entity to change the wiper blade, retrieving wiper information about the wiper blade of the vehicle, wherein the wiper information allows identification of a replacement part, relaying the wiper information to a second entity different from the first entity, and granting a right of use to the second entity for actuating a wiper system of the vehicle comprising the wiper blade.

### BACKGROUND

The present invention relates to a method for preparing a change of a wiper blade of a vehicle. The invention further relates to a computer program. Furthermore, the invention relates to a correspondingly configured vehicle.

From the prior art, software applications are known for user terminals, such as cell phones, by means of which a user is assisted in determining a replacement part to be obtained when the user wishes to change wiper blades of a vehicle. For example, the software application may assist in determining the necessary type of wiper blade and/or a suitable offer in an online store.

If the user wishes to change the wiper blade, the user typically has to cause the vehicle to place the wiper in a service position. The windshield wipers are typically disposed in an aerodynamically optimized manner so that changing the wiper blades in a normal idle state is not possible. In order to displace the windshield wipers, the ignition of the vehicle typically needs to be switched on first. In a parked state with the ignition off, the drive of the windshield wiper is typically not supplied with electrical power. In electric vehicles, the state of the ignition being switched on typically corresponds to the state in which the high-voltage battery of the vehicle is connected to the vehicle's electrical power system and the vehicle is ready to drive. In a parking state in which the vehicle is not ready to drive, the high-voltage battery is typically disconnected from the on-board power system.

### SUMMARY

The method according to the invention for preparing a change of a wiper blade of a vehicle comprises the following steps: First, authenticating a first entity as an authorized user of the vehicle takes place. This may be done by means of a software key or hardware key, or by means of a code input. For example, the first entity may be an owner of the vehicle authenticating via an application on a cellular device. Thereafter, detecting of a wish of the first entity to change the wiper blade takes place. This is done in particular by means of a corresponding input by the first entity.

Retrieving of wiper information about the wiper blade of the vehicle also takes place. The retrieved wiper information enables identifying a replacement part to change the wiper blade. Thus, it is not necessary to select a suitable replacement part for the vehicle from a variety of available spare parts; rather, the necessary replacement part, i.e. a necessary replacement wiper blade, can be identified directly. Said wiper information is forwarded to a second entity different from the first entity. For example, the second entity is a service technician to change the wiper blade.

Further, a right of use for controlling a wiper system of the vehicle comprising the wiper blade is granted to the second entity. The second entity therefore need not be an authorized user of the vehicle. The second entity may still cause the vehicle to place the wiper blade in a service position to perform a wiper blade change.

A user of the vehicle authorized to use the vehicle, therefore, may simply and easily initiate a change of the wiper blade. The user need not be at the vehicle for the change itself and, more preferably, need not pass any hardware keys or the like to the second entity, i.e., in particular, a service operation.

Preferably, the right of use is limited to controlling the wiper system. In particular, the second entity cannot start or drive the vehicle. It is thus ensured that only a change of the wiper blade can take place, wherein unwanted use of the vehicle is prevented.

In a preferred embodiment, in addition to retrieving wiper information, retrieving vehicle information from the vehicle is also performed. Thus, identifying the vehicle can be easily performed based on the vehicle information. The vehicle information includes, in particular, a location and/or type and/or visual features of the vehicle. The vehicle information is also transmitted to the second entity. Thus, the first entity may perform the preparation of the change of wiper blade without parking the vehicle at a pre-arranged or predetermined location. The second entity then receives both the location and a type and/or visual features of the vehicle. Based on said data, the second entity can identify the location of the vehicle and the vehicle itself. Then, the wiper blade may be changed without the need for the first entity to be present at any time.

The right of use is in particular only valid for a predefined period of time. Thus, it is ensured that the required right of use is present only for the intended change of the wiper blade, but that continuous or prolonged access to the vehicle is prevented. The predefined time period can in particular be determined in advance by the first entity.

Preferably, the right of use includes permission to unlock and/or open a hood and/or service hatch to refill windshield cleaning fluid. Thus, in addition to purely changing the wiper blade, a windshield cleaning fluid may also be refilled. By means of a corresponding embodiment of the right of use, the first entity may enable and prevent access to particular components of the vehicle.

The invention further relates to a method for preparing a change of a wiper blade of a vehicle comprising the following step. First, receiving of wiper information identifying a wiper blade to be changed takes place. In addition, a right of use for actuating a wiper system of the vehicle comprising the wiper blade is received. The method thus allows the wiper blade to be changed, the method being provided in particular for entities that are not a permanent user of the vehicle or have no permanent right of use. Said entities obtain a right of use allowing at least displacing the wiper blade, which is advantageous for service personnel, for example. Using the wiper information, the wiper blade to be replaced can be clearly identified in order to obtain a suitable replacement part. The method also comprises the step of transmitting an actuation command to the vehicle to place the wiper blade in a predefined service position. Said transmitting is in particular in response to a user input. Thus, actuating the vehicle for displacing the wiper blade can be performed by using the obtained right of use. Particularly advantageously, receiving of vehicle information also takes place as previously described.

The invention also relates to a computer program. The computer program is configured to perform a method as previously described.

Particularly advantageously, the computer program is configured to execute on a user terminal. The user terminal is in particular a cell phone. The first entity may thus prepare to change the wiper blade at any time, at least as long as access to the user terminal exists, as previously described. Alternatively, the computer program is configured to execute on a vehicle computer of the vehicle or to execute on a server communicatively connected to the vehicle. Thus, changing the wiper blade can be simply and easily prepared from of the vehicle.

The invention further relates to a vehicle. The vehicle comprises a wiper system and a control unit. The wiper system in turn comprises at least one wiper blade and a drive. The wiper blade can be displaced by the drive. The control unit is at least configured to actuate the drive. In addition, the control unit is configured to receive an actuation command for the drive from an entity. The entity is not part of the vehicle and thus has a particular right of use for the vehicle. The control unit is configured to cause the drive to place the wiper blade in a predefined service position upon receipt of the actuation command. Thus, the vehicle permits external actuating of the drive of the wiper system, in particular meaning that the actuating does not originate from a component of the vehicle itself. Rather, a communication link between the vehicle and an external device is preferably provided, wherein the actuation command is transmitted via said communication link. Particularly advantageously, the external device, i.e., the entity named above, does not have any rights to open or start the vehicle. It may only be provided that service hatches of the vehicle may be unlockable or openable by said entity.

The control unit advantageously comprises a zone control unit and a vehicle computer. The zone control unit is networked with the vehicle computer for data transfer and advantageously serves to actuate and/or control a sub-area of the vehicle. The zone control unit is in particular configured to actuate the drive. The zone control unit thus allows actuating the drive of the wiper system at any time, regardless of an operating state of the vehicle.

Advantageously, the control unit is configured to actuate the drive to displace the wiper blade while an ignition of the vehicle is switched off and/or a high-voltage battery is disconnected from an on-board power system of the vehicle. For example, actuating may also be carried out when the vehicle is parked and, in particular, locked.

### BRIEF DESCRIPTION OF THE DRAWINGS

In the following, exemplary embodiments of the invention are described in detail with reference to the accompanying drawings. The drawings show:

FIG. 1 a schematic view of a vehicle according to an exemplary embodiment of the invention, and

FIG. 2 a schematic view of incorporating a drive of a windshield wiper system of the vehicle into a communication-enabled environment.

### DETAILED DESCRIPTION

Preferably, all identical components, elements, and/or units are provided with the same reference symbols in all figures.

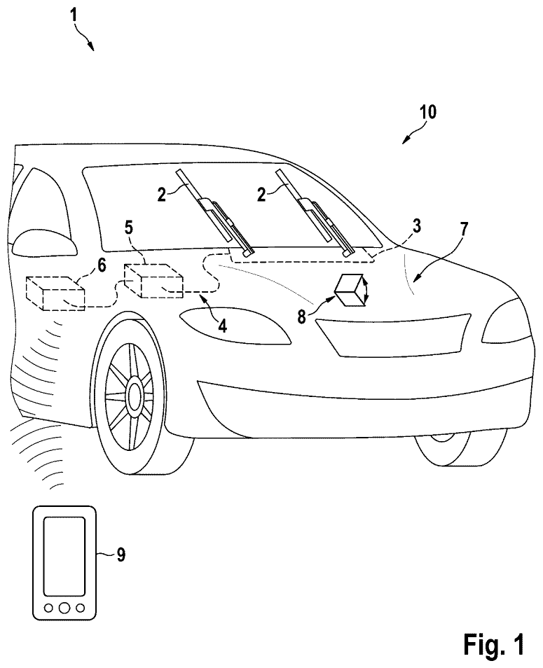

FIG. 1 shows a schematic view of a vehicle 1 according to an exemplary embodiment of the invention. The vehicle 1 comprises a wiper system 10 and a control unit 4. In the exemplary embodiment shown, the wiper system 10 comprises two wiper blades 2 and a drive 3 provided for displacing the wiper blades 2. According to the invention, the wiper system may also comprise a plurality of or fewer wiper blades. The drive serves in particular for displacing the wiper blades 2 so that said blades clean or wipe a surface, for example a windshield of the vehicle 1.

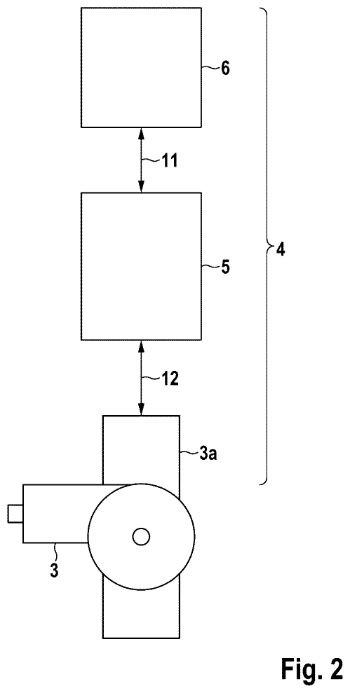

The control unit 4 is shown schematically in FIG. 2 and comprises a zone control unit 5 as well as a vehicle computer 6. The zone control unit 5 is provided for actuating a sub-area of the vehicle 1 and serves for actuating the drive the drive 3, at least among other things, in the exemplary embodiment shown. The drive 3 and zone control unit 5 are connected, for example, via a field bus 12, in particular by a Local Interconnect Network, also known as a LIN bus, or by a Controller Area Network, also known as a CAN bus. The zone control unit 5 is networked to the vehicle computer 6 for data transfer, wherein the communication between the zone control unit 5 and the vehicle computer is, for example, an Ethernet-based network connection 11 and is based on the Internet Protocol (IP). In this way, the drive 3 is integrated into a communication environment and can be actuated very flexibly. In particular, networking via a mobile data connection is made possible. The drive 3 is not limited to actuating by means of the vehicle 1 itself, for example, switches, levers or touch screens.

The control unit 4 is configured to receive an actuation command for the drive 3 from an entity that is not part of the vehicle 1. In particular, said entity has a separate right of use for the vehicle 1, but said right is preferably limited. Thus, the entity may be allowed to actuate the drive 3 or perform other service functions, wherein opening or starting the vehicle 1 is prevented in particular. Thus, the vehicle 1 is optimally prepared for maintenance purposes, as service personnel can obtain independent usage rights to perform necessary measures. Any additional rights may be denied to the service personnel. It is provided in particular that, upon receipt of the aforementioned actuation command, the control unit 4 causes the drive 3 to place the wiper blade 2 in a predefined service position. In addition, the control unit 4 is preferably configured to actuate the drive 3 while an ignition is switched off and/or a high-voltage battery is disconnected from the on-board power system of the vehicle 1 in order to displace the wiper blade 2. Thus, for example, opening a passenger compartment or entering the vehicle 1 is not necessary; it is possible even for a parked vehicle 1 to place the wiper blades 2 in a service position. Unintended use of the vehicle 1 may thus be prevented.

A change of the wiper blades 2 can be particularly advantageously prepared. To this end, a method according to a first exemplary embodiment of the invention is carried out, wherein the method is carried out in particular by a computer program. The computer program is preferably executed on a user terminal 9, for example on a cell phone.

To prepare a change of the wiper blades 2 of the vehicle 1, authenticating a first entity as an authorized user of the vehicle 1 first takes place. This may be done, for example, in that the first entity, for example corresponding to an owner of the vehicle 1, has a matching key. The key is particularly advantageously a software key stored on the user terminal 9 or in a cloud. Thus, it is ensured that only authorized users of the vehicle can be the first entity.

Recognizing a desire of the first entity to change the wiper blade is further carried out. This can be done in particular by means of a corresponding input, for example on the user terminal 9.

Subsequently, wiper information about the wiper blade 2 to be changed or the wiper blades 2 of the vehicle 1 to be changed is retrieved. The wiper information allows identifying a replacement part and comprises, for example, a unique identification number and/or type and/or dimension and/or designation of the respective wiper blade to be changed. For example, the wiper information may be stored in a database for associating the wiper blades to be used with a particular type of vehicle. Retrieving wiper information does not require the first entity to determine the replacement part to be used itself.

In addition to retrieving wiper information, vehicle information is also particularly advantageously retrieved from the vehicle. The vehicle information preferably includes a location and/or a type and/or visual features of the vehicle. Thus, the vehicle may be unambiguously detected based on the vehicle information.

The wiper information, and in particular also the vehicle information, is forwarded to a second entity different from the first entity. The second entity is, in particular, a service facility and/or service personnel. The latter receives an order to change wiper blades 2 on the vehicle 1, wherein a change can also be made remotely if a location of the vehicle has been transmitted based on the vehicle information. The second entity has the necessary information to obtain a replacement part for the wiper blades 2 used in the vehicle 1 in order to thus perform a change. Viewing of the vehicle 1 in advance to determine the necessary type of the wiper blade 2 is not necessary.

In order for the wiper blades 2 to be changed, a right of use for controlling the wiper system 10 of the vehicle 1 is also granted to the second entity. The right of use allows the drive 3 to actuate the wiper blades 2 to place the wiper blades 2 in a predefined service position.

The benefit of granting the right of use is in particular an avoidance of physical handover of a physical key. Rather, the right of use may be granted without the need for a physical meeting between a user of the vehicle 1 and the service personnel. For example, the vehicle 1 may be parked and exited, wherein the second entity knows a location and other features for identifying the vehicle 1 based on the vehicle information. The right of use allows the second entity to place the wiper blades 2 in the service position and to replace the same, with necessary replacement parts being known in advance based on the wiper information. Changing the wiper blades 2 is thus simply and efficiently possible.

In order to increase security when granting the right of use, the right of use is only valid for a predefined period of time. This ensures that the right of use expires again after the replacement of the wiper blades 2 has been completed. Also, a time frame for changing the wiper blades 2 can thus be provided.

The right of use may also permit the unlocking and/or opening of a hood 7 and/or service hatch 8 of the vehicle 1. In this case, the service hatch 8 and/or the hood 7 are necessarily to be opened, in particular for refilling windshield cleaning fluid. Permitting said openings makes it convenient to carry out a service related to a wiper blade, refilling the windshield cleaning fluid. Nevertheless, full access to the vehicle 1 is not necessary for this purpose and thus is not granted. Thus, the right of use includes only such interactions with the vehicle 1 that are necessary and/or desired by the first entity.

In particular, from the perspective of the second entity, a method for preparing a change of a wiper blade 2 of a vehicle 1 according to a second exemplary embodiment of the invention is performed. The method begins with receiving wiper information identifying the wiper blade 2 to be changed or the wiper blades 2 to be changed. Thus, it is known which spare parts are needed to replace the wiper blade 2 or the wiper blades 2. In addition, a right of use for actuating the wiper system 10 of the vehicle 1 is received, whereby the wiper blades 2 may be placed in a service position. As a last step, an actuation command is sent to the vehicle 1 for placing the wiper blade 2 in the predefined service position. Transmitting takes place in particular in response to user input and may be separated in time from receiving the wiper information. In addition to the wiper information, vehicle information may also be received as previously described.

1. A computer-implemented method for preparing a change of a wiper blade (2) of a vehicle (1), the method comprising the steps of
authenticating, via a computer, a first entity as an authorized user of the vehicle (1),
detecting, via the computer, a desire of the first entity to change the wiper blade (2),
retrieving, via the computer, wiper information about the wiper blade (2) of the vehicle (1), the wiper information allowing identification of a replacement part,
forwarding, via the computer, the wiper information to a second entity different from the first entity, and
granting, via the computer, a right of use to the second entity for actuating a wiper system (10) of the vehicle (1) comprising the wiper blade (2).

2. The method according to claim 1, wherein, in addition to retrieving wiper information, vehicle information is also retrieved from the vehicle (1) and forwarded, the vehicle information comprising a location and/or type and/or optical features of the vehicle (1).

3. The method according to claim 1, wherein the right of use is only valid for a predefined period of time.

4. The method according to claim 1, wherein the right of use includes permission to unlock and/or open a hood (7) and/or service hatch (8) for refilling windshield cleaning fluid.

5. A method for preparing a change of a wiper blade (2) of a vehicle (1), comprising the steps of
receiving wiper information identifying a wiper blade (2) to be changed,
receiving a right of use for actuating a wiper system (10) of the vehicle (1) comprising the wiper blade (2), and
transmitting, in in response to a user input, an actuation command to the vehicle (1) for placing the wiper blade (2) in a predefined service position.

6. A non-transitory, computer-readable medium containing instructions that when executed by a computer cause the computer to
authenticate a first entity as an authorized user of a vehicle (1),
detect a desire of the first entity to change a wiper blade (2),
retrieve wiper information about the wiper blade (2) of the vehicle (1), the wiper information allowing identification of a replacement part,
forward the wiper information to a second entity different from the first entity, and
grant a right of use to the second entity for actuating a wiper system (10) of the vehicle (1) comprising the wiper blade (2).

7. The non-transitory computer-readable medium according to claim 6, wherein the computer comprises a cell phone or a vehicle computer (6) of the vehicle (1), or a server communicatively connected to the vehicle (1).

8. A vehicle (1) comprising
a wiper system (10) having at least one wiper blade (2) and a drive (3), the wiper blade (2) being displaceable by means of the drive (3), and
a control unit (4) for actuating the drive (3),
wherein the control unit (4) is configured to receive an actuation command for the drive (3) from an entity that is not part of the vehicle (1) and to cause the drive (3) to place the wiper blade (2) in a predefined service position.

9. The vehicle (1) according to claim 8, wherein the control unit (4) comprises a zone control unit (5) as well as a vehicle computer (6), wherein the zone control unit (5) is networked with the vehicle computer (6) for data transmission, and wherein the zone control unit (5) is configured to actuate the drive (3).

10. The vehicle (1) according to claim 8, wherein the control unit (4) is configured to actuate the drive (3) while the ignition is switched off and/or a high-voltage battery is disconnected from the vehicle (1) in order to displace the wiper blade (2).
